(19) United States
(12) Patent Application Publication
(10) Pub. No.: US 2008/0275701 A1
(43) Pub. Date: Nov. 6, 2008

(54) SYSTEM AND METHOD FOR RETRIEVING DATA BASED ON TOPICS OF CONVERSATION

(76) Inventors: Xiaotao Wu, Metuchen, NJ (US); Krishna Kishore Dhara, Dayton, NJ (US); Vankatesh Krishnaswamy, Holmdel, NJ (US)

Correspondence Address: MG-IP Law, PLLC, PO BOX 1364, FAIRFAX, VA, 22038-1364, US

(21) Appl. No.: 12/109,670

(22) Filed: Apr. 25, 2008

Related U.S. Application Data
(60) Provisional application No. 60/913,934, filed on Apr. 25, 2007.

(51) Int. Cl. G10L 15/26; G10L 15/04

(52) U.S. Cl. 704/235; 704/251; 704/E15.001

(57) ABSTRACT

A method includes performing computerized monitoring with a computer of at least one side of a telephone conversation, which includes spoken words, between a first person and a second person, automatically identifying at least one topic of the conversation, automatically performing a search for information related to the at least one topic, and outputting a result of the search. Also a system for performing the method.

### CROSS-REFERENCE TO RELATED APPLICATIONS

This application claims the benefit of U.S. Provisional Patent Application 60/913,934, filed Apr. 25, 2007, the entire contents of which are hereby incorporated by reference.

### FIELD OF THE INVENTION

The present invention is directed to a system and method for retrieving data based on the content of a spoken conversation and, more specifically, toward a system and method for recognizing the speech of at least one participant in a conversation between at least two participants, determining a topic of the speech, performing a search for information related to the topic and presenting results of the search.

### BACKGROUND OF THE INVENTION

People maintain large amounts of data on their computers and other networked devices. This information includes data files, contact information for colleagues and hundreds or thousands of email messages. The entire contents of the world wide web is also available to a user by performing a search with a commercially available search engine. This wealth of information is sometimes difficult to navigate efficiently, and various search tools have been developed to help people take advantage of the information available to them. These tools include internet search engines such as Google and similar search engines for indexing the contents of a user's computer or network to make the rapid retrieval of relevant documents possible based on keyword searches. However, such keyword searching requires the attention of a user, and it is generally necessary for the user to stop one task to engage in a search for desired documents. Furthermore, the user must have some idea that a relevant document exists before performing a search.

When people communicate by telephone, it is often desirable to have access to various documents and other information relevant to the telephone conversation and to share this information with the other party or parties to the conversation. For example, when a customer speaks with a vendor about an ongoing project, it would be useful to have project information available. When it becomes clear from the conversation that another person should be involved in the discussion or should be contacted for additional information, that person's contact information must be retrieved. It would also be useful to have available information from previous conversations and to know what other team members have discussed with that vendor in the past.

Some of this information may be obtained before a conversation occurs. For example, before calling the vendor, the customer may retrieve notes from a previous conversation or may download the latest specifications for the project from a company server. During the course of the conversation, the customer may email or send via instant message (IM) relevant information to the vendor. Both parties may perform searches of the world wide web during the conversation to locate additional relevant information or answer questions that arise as they speak. And, if other people must be contacted for additional information, the party having the contact information for that party can either contact that party or read or send the contact information to the other party. It would be desirable to make relevant documents and information available to the participants in a telephone conversation in a more automated manner, including documents of which the participants might not be specifically aware.

### SUMMARY OF THE INVENTION

These problems and others are addressed by the present invention, a first aspect of which comprises a method of performing computerized monitoring of at least one side of a telephone conversation between a first person and a second person, automatically identifying at least one topic of the conversation, automatically performing a search for information related to the at least one topic, and outputting a result of the search.

Another aspect of the invention comprises a system for providing at least one participant in a telephone conversation between a first person and a second person with information related to a topic of the conversation. The system includes a first data set containing words or phrases, a second data set comprising documents, and at least one computer receiving voice input from at least the first person. The at least one computer is configured to perform automatic speech recognition on the input to find words or phrases in the input that match words or phrases in the first data set, to search the second data set to locate documents including the matched words or phrases, and to make the identified documents available to the first person.

A further aspect of the invention comprises a computer readable recording medium storing a program for causing a computer to perform computerized monitoring of at least one side of a telephone conversation between a first person and a second person, to automatically identify at least one topic of the conversation, to automatically perform a search for information related to the at least one topic, and to output a result of the search.

### BRIEF DESCRIPTION OF THE DRAWINGS

These and other aspects of embodiments of the invention will be better understood after a reading of the following detailed description together with the following drawings wherein:

FIG. 1 is a schematic illustration of a system including a telephone and a computer for implementing the invention of an embodiment of the present invention;

FIG. 2 is a schematic illustration of person having a conversation on the telephone of FIG. 1;

FIG. 3 is an elevational view of the display of the computer of FIG. 1;

FIG. 4 is an elevational view of a cellular telephone used with a monitoring system according to an embodiment of the present invention;

FIG. 5 is a schematic illustration of a first system for implementing the invention of an embodiment of the present invention in an enterprise setting;

FIG. 6 is a schematic illustration of second system for implementing the invention of an embodiment of the present invention in an enterprise setting;

FIG. 7 is a schematic illustration of a third system for implementing the invention of an embodiment of the present invention in an enterprise setting;

FIG. 8 is a schematic illustration of fourth system for implementing the invention of an embodiment of the present invention in an enterprise setting;

FIG. 9 illustrates a protocol for automatically obtaining recording consent;

FIG. 10 schematically illustrates a method of file sharing according to an embodiment of the invention;

FIG. 11 is a call flow diagram for the method of file sharing illustrated in FIG. 10;

FIG. 12 is a schematic illustration of fifth system for implementing the invention of an embodiment of the present invention in an enterprise setting; and

FIG. 13 is a flow chart illustrating a method according to an embodiment of the present invention.

### DETAILED DESCRIPTION

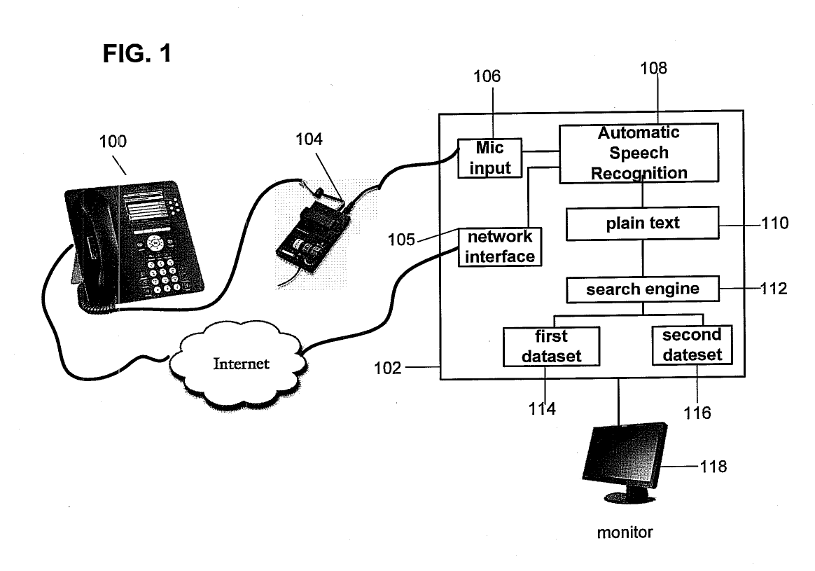

A first embodiment of the present invention comprises a system for presenting a user with access to relevant information based on the content of the user's telephone conversation. Referring now to the drawings, wherein the showings are for purposes of illustrating preferred embodiments of the invention only and not for the purpose of limiting same, FIG. 1 illustrates a telephone handset 100 connected to a computer 102 via a splitter 104 that allows a user's voice to be input to the microphone input 106 of the computer while the user talks on the telephone 100. A suitable splitting device is the MX10 headset switcher multimedia amplifier available from Avaya, Inc. It will be appreciated that if the user is using a software-based telephone running on the user's computer 102, that software telephone could monitor users' talk by receiving digitalized voice stream on the network interface 105 through the Internet.

From the microphone input 106, the user's speech is provided to an automatic speech recognition (ASR) module 108 which produces a text file 110 containing a transcript of at least the side of the telephone conversation input via telephone 100. A search engine 112 searches the text file 110 for words and/or phrases that are present in a first data set 114, and when a match is found, searches a second data set 116 for documents containing the matched words or phrases. The output is then sent to a user's computer monitor 118.

First data set 114 can be manually populated by the user. Information included in the first data set 114 may include names in the user's contacts list or a company contacts list, trademarks or product names of products sold or purchased by the company, the names of projects or file numbers used in the company to identify projects under development internally, the names of competitors, vendors, customers and/or any other terms or phrases that might be expected to be a topic of a user's conversation. Alternately, or in addition, first data set 114, might be populated semi-automatically by indexing the text of a user's emails or email subject lines and removing common words or words that are unlikely to identify a topic of conversation therefrom. First data set 114 is illustrated in FIG. 1 as being physically stored on computer 102 but could be stored elsewhere and accessed by computer 102 via a network.

Second data set 116 can comprise the user's email messages, contacts list, and/or text documents stored on the user's computer. Second data set 116 can also include information available to the user via a network, such as files stored on a company server, files created by the user and/or files created by others. Second data set 116 could also include documents available over the world wide web.

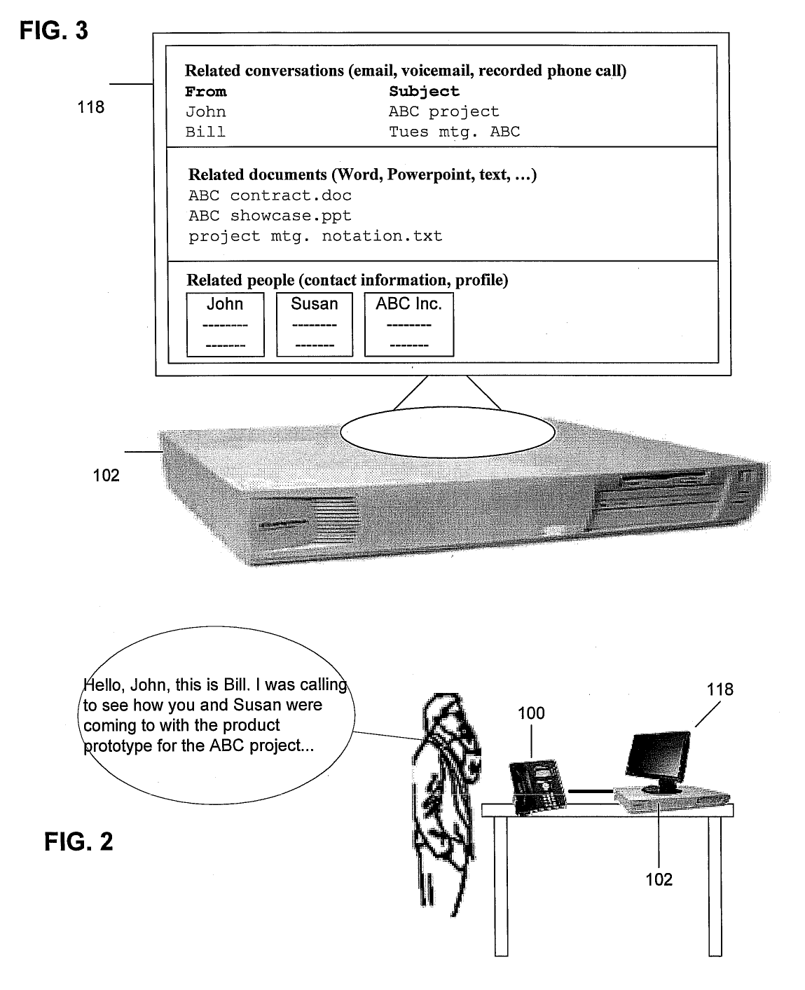

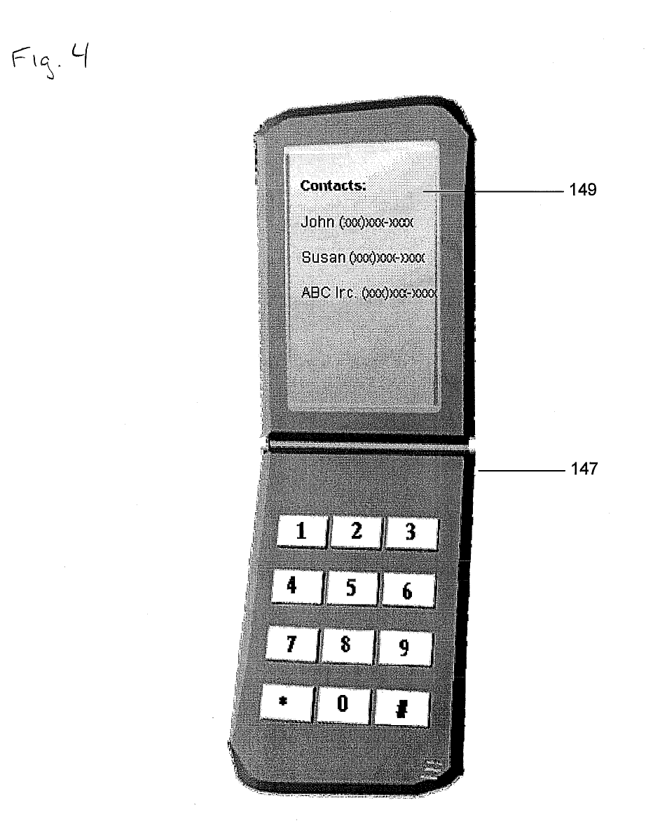

In use, as illustrated in FIGS. 2 and 3, a user places or receives a telephone call using telephone 100 which is connected to computer 102 operating according to an embodiment of the present invention. As the user speaks to a second party (not shown), the user's voice is fed into the desktop computer 102 where ASR module 108 creates a text file of the spoken words and searches first data set 114 for matching words or phrases. Assume that at least the names “John,” “Susan” and the word “ABC” or phrase “ABC project” are stored in the first data set. As the user, “Bill,” speaks into his telephone, a search engine 112 searches the second data set 116 for relevant documents based on the matching words. In this example, second data set 116 includes the user's email messages, text files created by the user, and the user's contacts list. As should be clear from this description, second data set 116 does not necessarily comprise a single file but rather can comprise multiple data sources that are searched by search engine 112. As is known in the art, these sources may be indexed by a suitable indexing program to reduce the time required for search.

As person 100 speaks, search engine 112 outputs the results of the search to monitor 118, which search results include email messages that include “ABC” or “ABC project” in their subject lines. One of the email messages is also from “John” which might be the “John” participating in the telephone conversation, and this messages is displayed first as possibly being of higher importance than messages that do not appear to involve the present participants of the telephone conversation. In a separate frame, the names of various Microsoft Word documents are displayed which appear to be relevant to the ongoing conversation based on their titles and/or contents. Finally, contact information for “Susan” mentioned in the telephone conversation and contact information for “ABC, Inc.” are also displayed.

An ongoing series of searches will be conducted by search engine 112 as the conversation continues. Search results that were produced early in a call will remain relevant as the call progresses, but more recent searches may provide results that are more relevant to the user at that stage of the conversation. Based on this observation, the importance of an item I can be defined with respect to its relative search sequence number r and its position i as follows: I(r,i)=Cr*Ri*Ar, where Cr represents the speech recognition confidence value of the keywords that are used to perform the search, Ri represents the relevant factor of the ith item to the keywords of the rth search, and Ar represents the aging factor of the rth search, the bigger the r, the smaller the Ar. The results should be displayed in the descending order of the I (r,i). In this manner, the most current results presented to the user represent the most recent topics of the conversation, and have the highest probability of being relevant to the person speaking.

When the system is implemented using a conventional telephone, computer 102 handles audio streams without the knowledge of the call session, e.g., the participants of the call. Therefore content-related information located by search engine 112 cannot readily be shared with other users. When the telephone comprises a software based telephone running on the user's computer, the softphone acts as a back-to-back user agent (B2BUA) to bring the user's phone into conversations and relay audio streams to the user's phone. Since audio streams from both sides of a conversation, as well as call signaling, pass through the softphone, the softphone has the complete knowledge of call sessions and can perform more content aware services, e.g., conferencing other people into a call session and searching for topics coming from multiple parties to a conversation.

The embodiment described above provides useful information for the first party to the telephone conversation. When a softphone is used, the person implementing the search system according to embodiments of the present invention obtains the benefit of searches based on topics mentioned by other parties to the conversation as well. However, the information provided to the user on monitor 118 is not readily available to the other party or parties to the conversation. This situation is addressed by a second embodiment of the present invention that operates in a distributed system to allow searches to be conducted based on multiple parts of a conversation and that allows the results of those searches to be made available to multiple parties to the conversation.

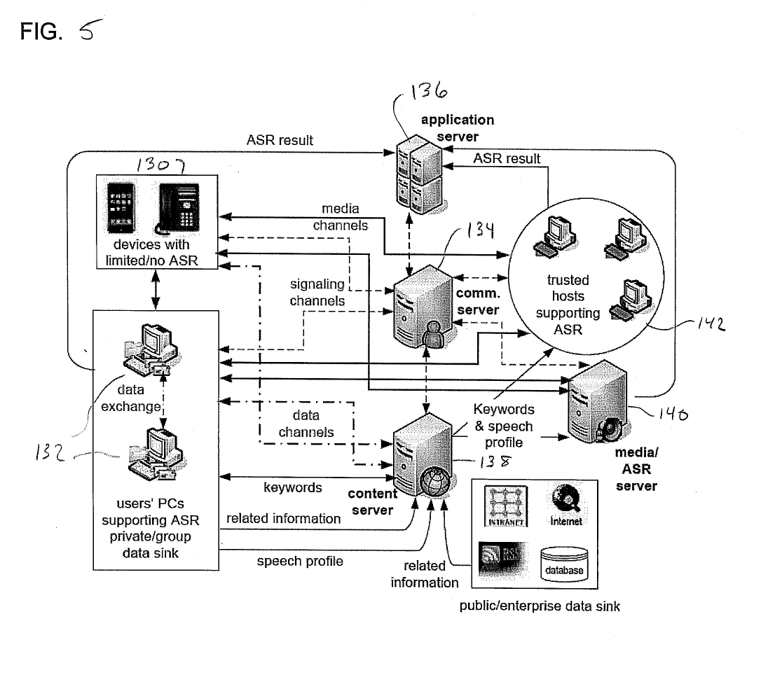

FIG. 5 schematically illustrates an architecture for an enterprise-based content aware voice communication system. The architecture includes a first endpoint 130 in the form of a conventional telephone or a telephone with limited ability to perform ASR. Also illustrated are user computers 132 that may support softphone software as discussed above or that may be available to perform ASR for a computer or telephone lacking adequate resources for this function. The architecture also includes a communication server 134, an application server 136, a content server 138 and a media/ASR server 140. Content server 138 is also in communication with trusted hosts 142 that can perform ASR.

In the architecture, the communication server 134 serves as a central point for coordinate signaling, media, and data sessions. Security and privacy issues are handled by the communication server 134. The application server 136 hosts enterprise communication services, including content-aware communication services. The content server 138 represents an enterprise repository for information aggregation and synthesization. The media/ASR server 140 is a central resource for media handling, such as ASR and interactive voice response (IVR). In this architecture, media handling can be distributed to different entities, such as to users' computers and to trusted hosts 142 connected via an intranet. For an enterprise employee, the trusted hosts 142 can be computers of his or her team members or shared computers in his or her group.

In such an architecture, ASR can be handled by different entities. The application server 136 decides which entity to use based on the computation capability, expected ASR accuracy, network bandwidth, audio latency, and the security and privacy attributes of each entity. In general, ASR should be handled by users' own computers for better scalability, ASR accuracy, and easier security and privacy handling. If a user's own personal computers is not available, trusted hosts 142 should be employed. The last resort is the centralized media server 140.

In the architecture, the application server 136 can monitor an ongoing call session through the communication server 134, e.g., by using SIP event notification architecture and SIP dialog state event package. The application server 134 then creates a conference call based on the dialog information and bridges an ASR engine into the conference for receiving audio streams. The conference call can be hosted at an enterprises' Private Branch exchanges (PBXs), a conference server, or at a personal computer in the enterprise depending on the capabilities of that computer. Capability information for each computer can be retrieved by using SIP OPTIONS methods, and a conference call can be established by using SIP REFER methods. In general, a computer with a moderate configuration can easily handle a 3-way conferencing and perform ASR simultaneously.

The communication server 132 serves as the central point to coordinate all the components in this architecture, and handles security and privacy issues. The content server 138, application server 136, and media server 140 can be treated as trusted hosts to the communication server 132, and no authentication is needed. All the other components in the architecture should be authenticated. The application server 136 can decide which entity should perform ASR for a user based on hierarchical structure of an enterprise. For example, team members may share their machines. Sharable resources of a department, such as lab machines, can be used by all department members.

The above-described system was implemented for a single user using a modest PC with a 3.0 GHz Intel processor and 2.0 GB of memory and was able to handle a 3-way conference call with G711 codec. This arrangement required 10 to 20 seconds to recognize a 20 second audio clip, or 700 ms to recognize a keyword in a continuous speech by using a Microsoft speech engine. The ASR time can be reduced to 3 to 5 seconds for a 20 second audio clip on a better dual-core computer with Intel Core 2 Duo 1.86 GHz processors and 1.0 GB of memory. However, if there are other processes occupying CPU cycles, the ASR time will increase.

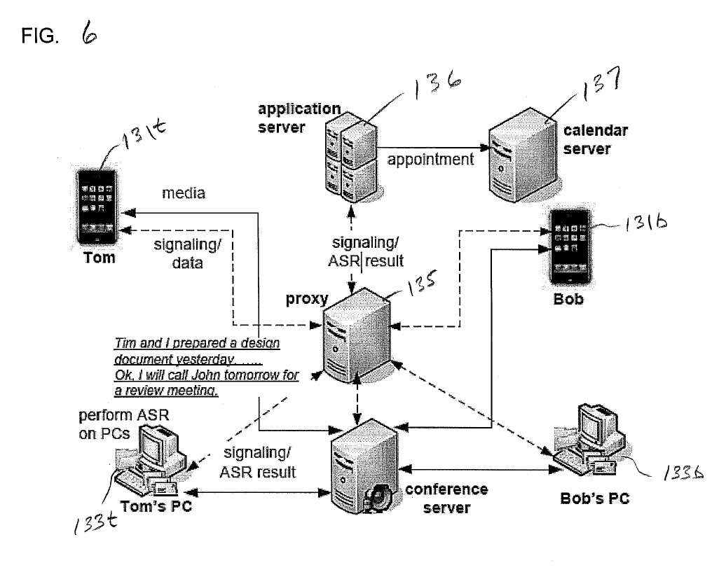

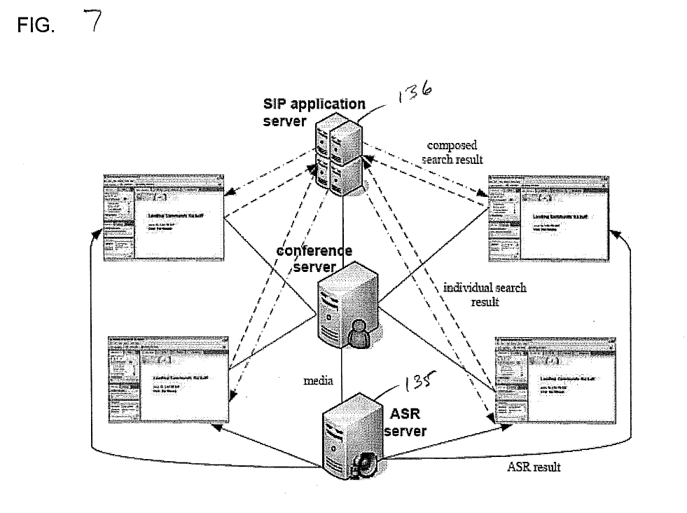

FIG. 6 illustrates another embodiment of the present invention in which two users, Tom and Bob speak to one another over mobile telephones 131t, 131b, while away from their offices and personal computers 133t, 133b. During the conversation, Tom mentions a document and indicates that he plans to make a call to John. The ASR server 135 recognizes that the mentioned document is a topic of the conversation, and the application server 136 then finds the mentioned document on Tom's PC and displays a link to the document on Tom's phone. Tom clicks a “send” button on his phone and Bob clicks a “confirm” button on his phone, and this establishes a file transfer session to transfer the mentioned document Tom's PC to Bob's PC.

After the conversation, the application server 136 asks Tom to confirm a phone conference appointment with John. The reminder is then saved in the calendar server 137. In this scenario the system acts as a personal assistant to help users to intelligently handle conversation related issues. This scenario shows that individual content-aware services can be tightly bound to other resources people use often in their daily work, e.g., their personal computers. Indeed, users' computers can serve as both information sources and computing resources for content-aware services, especially for computation intensive tasks, such as ASR. For a large enterprise, it is not scalable to use a centralized media server to handle continuous speech recognition for all the employees. It is desirable to distribute ASR on users' computers for individual content-aware services.

FIG. 7 illustrates another embodiment of the present invention used when more than two persons are participating in a conversation. Rather than a personal assistant, a “group assistant” can be provided to coordinate and share information among group members e.g., based on the content of a conference. In FIG. 7, a web conference takes place and an ASR server 135 monitors the conversation. All the conference participants perform individual information retrieval based on the results of the automatic speech recognition. Because different people have different information sources for searching and different accessing privileges, the searching results can be very different. Those searching results can be collected at the application server 136, filtered, and shared among conference participants.

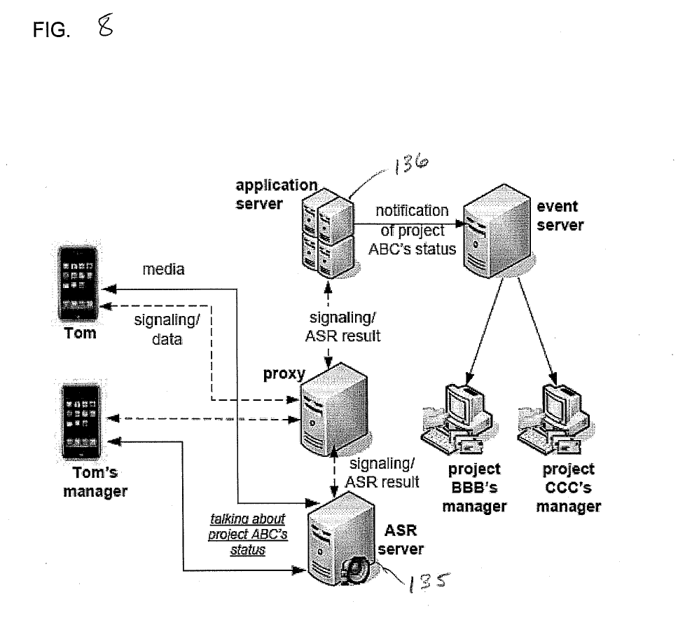

FIG. 8 illustrates another embodiment of the invention in which the results of the search are provided to a person other than one of the parties participating in the conversation. Such an embodiment may be used in Communication Enabled Business Processes (CEBP) which create more agile, responsive organizations. These systems can minimize the latency of detecting and responding to important business events by intelligently arranging communication resources and providing advisory and notifications. In this embodiment, the detected topics of conversations can be treated as inputs to CEBP solutions. For example, as shown in FIG. 8, a developer is reporting the progress of project ABC to his manager. The status of project ABC is detected as a topic of the conversation and reported to mangers of other projects which may depend on the status of project ABC.

The above-described systems use SIP event notification architecture for sending capability information from personal computers to the communication server 132. The application server subscribes to candidate personal computers for capability information. The capability information can be represented in the similar format as those defined in the Session Initiation Protocol (SIP) User Agent Capability Extension to Presence Information Data Format (PIDF).

As far as improving the accuracy of AVR, users can easily train their voices on their own computers. In this architecture, the individual computer of each system user is preferably used for ASR, and this makes it easier for the user to store a personal profile on that machine. The ASR can also be handled by trusted hosts 142. In this case, the speech profile of the user can be made available to the machine that handles ASR. Users can also store their trained profile on the content server 138.

Another way to improve ASR is to limit the size of vocabulary for ASR. In an enterprise, most conversations of a user revolve around a limited number of topics during a certain period of time. By applying Information Extraction (IE) technologies to existing users' documents, such as users' email archives, the size of the vocabulary for ASR can be reduced.

Network bandwidth and transmission delay can affect audio quality and in turn affect ASR accuracy. In the present architecture, due to security and privacy concerns, the candidate personal computers that are suitable to perform ASR for a user are usually very limited, e.g., to only the user's team members' personal computers or the personal computers with an explicit permission granted. The application server 136 can retrieve the information of those computers from the communication server 134 based on registration information, then determine which machine to use for audio mixing and ASR based on network proximity. For example, if an employee, whose office is in New York City, joins a meeting at Denver, his audio streams should be relayed to his Denver colleague's PC for ASR, instead of his own PC in New York City.

A system according to the present invention should function regardless of the abilities of the telephones placing and receiving calls. Under the present architecture, the content server is responsible for aggregating information from different sources, render it in an appropriate format and presenting it to users based on the devices the users are using. As illustrated in FIG. 4, for example, a cellular telephone 147 with a small display 149 may have a menu-driven interface. For a device that cannot display the content-related information, the content server 138 can generate a VoiceXML page, and the application server 136 can then bridge the media server 140, and play the VoiceXML page.

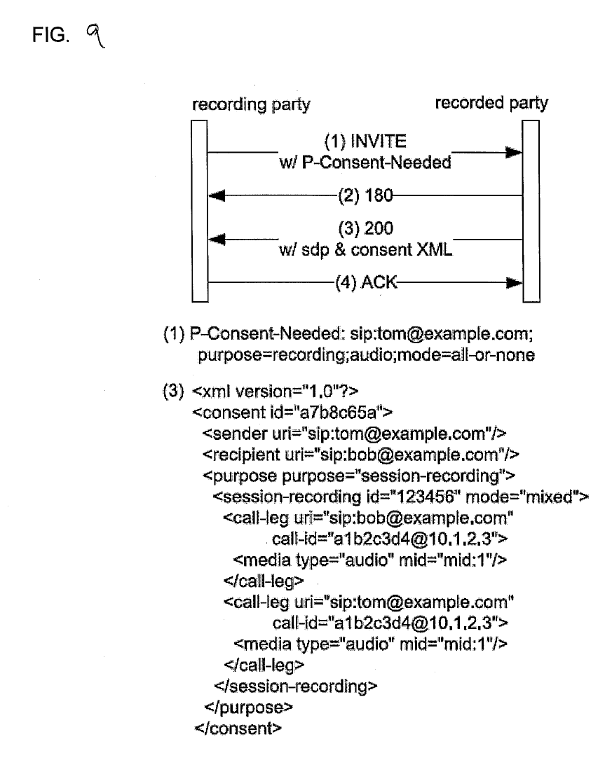

There are many federal and state laws and regulations governing the recording of telephone conversations. Federal law requires that at least one party to the call consent to the recording thereof; some state laws go further and require consent by all parties. In addition, FCC regulations require that all parties to an interstate call be notified of a taping before the call begins. These requirements affect whether calls can be recorded. In one method according to the present invention, SIP MESSAGE functionalities can be used to negotiate recording consent among parties to a conversation when necessary. For example, as illustrated in FIG. 9, a private SIP header “P-Consent-Needed” can be used to request recording consent. The consent can be represented in an XML format and carried in Multipurpose Internet Mail Extensions (MIME) using SIP requests or responses, e.g., SIP MESSAGE request.

Since the recorded audio is used for ASR, it may also be possible to comply with relevant laws by erasing the original recorded audio clips after they are analyzed. Finally, ASR might be performed based on real-time RTP streams without any recording.

If all necessary consents are obtained for a given conversation, recorded audio clips can be saved for offline analysis which may provide for more accurate ASR. The recorded audio clips can be also tagged based on the recognized words and phrases. The content server 138 can then coordinate distributed searching on saved audio clips which would become part of the second data set 116 searched by search engine 112.

Once the content of a conversation is obtained, the immediate use of the content is to find conversation topics so users can bring related people into the conversation and share useful documents. However, not all the related documents will be publicly available to all users. For example, the results of the desktop search of a PC are only available to the owner of the PC. In a conversation, in many cases, it is desirable to grant permission to the other conversation participants to access desktop search results and view related documents. In this architecture, the content server handles the aggregation and synthesization so that all users can see the same search results and access the documents and messages retrieved. When the retrieved documents include email messages or other potentially personal documents, however, it may be desirable to require input from the recipient of the message before sharing it with the other parties to a call.

Finding related information is just the first step for content aware services. In this architecture, users may share documents, click-to-call related people, and interact with other Internet services. Note that the services performed in this architecture are not independent of each other. Rather, they all fall into a unified application framework so feature interactions can be handled efficiently.

In enterprises, there usually are hundreds of communication services. New services should not interact with the existing services in an unexpected manner. In this architecture, the mechanisms defined in SIP Servlet v1.1 (JSR 289) for application sequencing are followed. The application router in JSR 289 application framework will decide when and how a content aware service should be invoked. For example, a user can provision his services so that if a callee has a call coverage service invoked and redirects the call to an IVR system, the content aware service will not be invoked. As another example, on a menu-driven phone display, an emergency message should override the content-related information screen, but a buddy presence status notification should not.

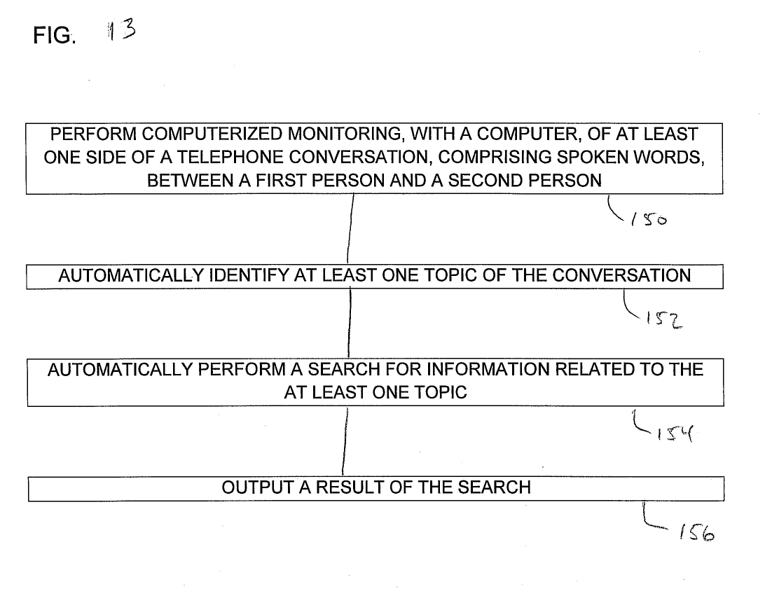

As illustrated in FIG. 12, a further embodiment of the present invention can be implemented using a Ubiquity SIP application server, which will provide JSR 289 support and host content aware service applications. Avaya's SIP Enablement Services (SES) and Communication Manager (CM) are used as the communication server, Avaya Voice Portal is used as the media server, and the content server is co-located on the Ubiquity server for simplicity. The content server uses Apache Tomcat 5.5 as a web server for VoiceXML retrieval. In the architecture, SIP MESSAGE and MSRP are used for data transportation so the data channels follow the same path as the signaling channels. Microsoft Office Communicator (MOC) and Avaya's MOC gateway may be used for desktop call control, Microsoft Speech SDK may be used for ASR on personal computers, Nuance's Dragon Naturally Speaking server may be used for ASR on Avaya's Voice Portal, and Google Desktop API (GDK) may be used for indexing and searching documents on personal computers.

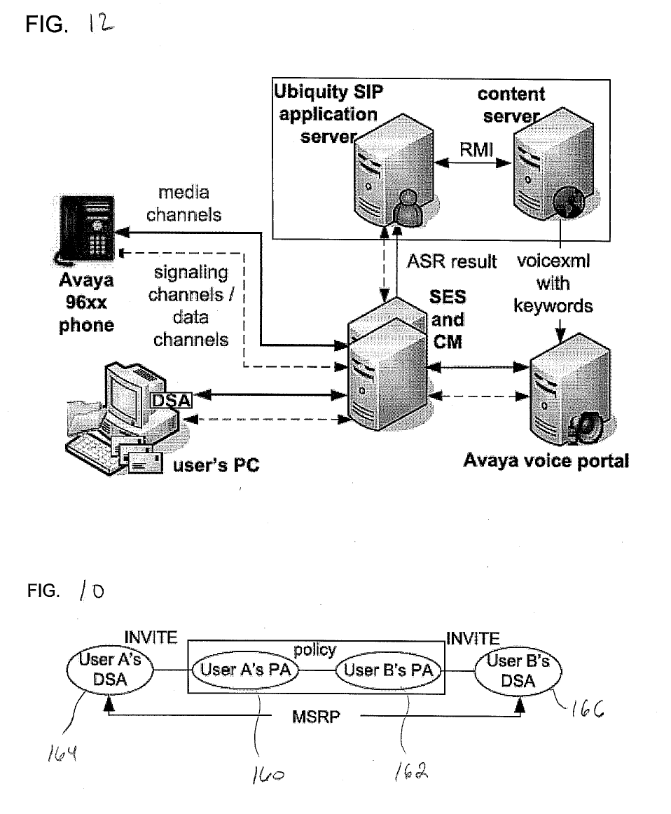

With reference to FIG. 10, phone control may be achieved by using an XML-based protocol called the IP Telephony Markup Language (IPTML). MOC is allowed to control phones through the Computer Supported Telecommunications Applications (CSTA) Phase III (ECMA-323). With phone control functions, users can perform click-to-dial operations and bring related people into a conversation. In the prototype, two users, user A and user B, for example each have a personal assistant 160, 162 and, for each user, the content aware service application registers a URI at the communication server for each user's URI. We call this URI the user's personal assistant (PA)'s URI. Each user's PA 160, 162 can receive the user's primary contact's dialog state events. The PA can then control the user's call sessions.

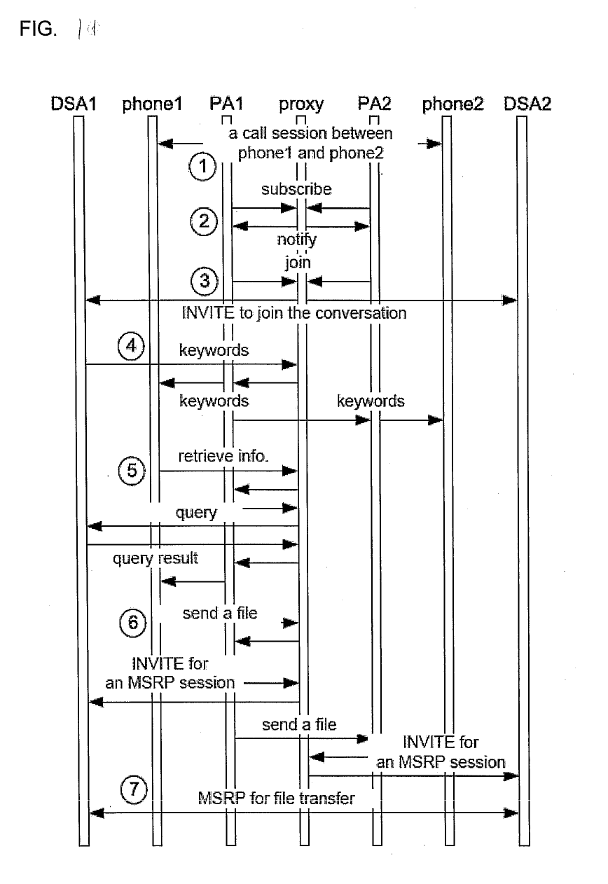

At users' personal computers, a SIP-based user agent runs as a Windows service called Desktop Service Agent (DSA), including a DSA 164 for user A and a DSA 166 for user B. DSA's 164, 166 register to the communication server and notify the communication server of their capabilities, such as their computation and audio mixing capabilities. DSA's 164 and 166 can accept incoming calls to perform ASR and IR and send the ASR and IR results by using SIP MESSAGE requests. A user's DSA only trusts requests sent from the user's PA. This way, policy-based automatic file sharing can be easily achieved by following the diagram shown in FIG. 10. In the diagram, the file transfer operation can be initiated on users' phones. The PAs get the request and serve as a B2BUA to establish a file transfer session by following the SDP offer/answer mechanism for file transfer. The real file transfer is then handled by the two DSAs 164, 166 using MSRP. FIG. 11 shows the call flow for content based searching and file transfer. In the figure, the file transfer operation can be initiated at users' phones. The PAs get the request and serve as a B2BUA to establish a file transfer session by following the session description protocol (SDP) offer/answer mechanism for file transfer. The real file transfer is then handled by two DSAs using message session relay protocol (MSRP). Notice that PA1 and PA2 are logically separated, but are part of the same application. They can communicate by function calls. In the service, PA2 allows messages from PA1 only if phone1 and phone2 are in the same communication session.

A method according to an embodiment of the present invention is illustrated in FIG. 13 and includes a step 150 of performing computerized monitoring with a computer of at least one side of a telephone conversation, comprising spoken words, between a first person and a second person, a step 152 of automatically identifying at least one topic of the conversation, a step 154 of automatically performing a search for information related to the at least one topic, and a step 156 of outputting a result of the search.

The present invention has been described herein in terms of several preferred embodiments. However, modifications and additions to these embodiments will become apparent to those of ordinary skill upon a reading of the foregoing description. It is intended that all such modifications comprise a part of the present invention to the extent they fall within the scope of the several claims appended hereto.

We claim:

1. A method comprising:
performing computerized monitoring with a computer of at least one side of a telephone conversation, comprising spoken words, between a first person and a second person;
automatically identifying at least one topic of the conversation;
automatically performing a search for information related to the at least one topic; and
outputting a result of the search.

2. The method of claim 1 wherein said step of automatically identifying at least one topic of the conversation comprises converting the spoken words to text and indexing the text.

3. The method of claim 1 including the additional step of defining a first set of terms and wherein said step of performing computerized monitoring comprises locating terms from the defined first set of terms in the spoken words.

5. The method of claim 1 wherein said step of automatically performing a search comprises the step of automatically performing a search of email messages of the first person.

6. The method of claim 1 wherein said step of automatically performing a search comprises the step of automatically performing a search of a contacts list of the first person.

7. The method of claim 1 wherein said step of automatically performing a search comprises the step of automatically searching the world wide web.

8. The method of claim 1 wherein said step of automatically performing a search comprises the step of automatically searching transcripts of past conversations.

9. The method of claim 1 wherein said step of outputting a result of the search comprises displaying the result on a display associated with the computer.

10. The method of claim 1 wherein said step of outputting a result of the search comprises displaying the result on a display associated with the telephone.

11. The method of claim 1 including the additional step of connecting the computer to a speech analysis server via a network, and wherein said step of performing automatic speech recognition comprises analyzing the speech at the speech analysis server and returning a result of the analyzing to the computer.

12. The method of claim 1 including the additional step of connecting the computer to a speech analysis server via a network and wherein said step of analyzing the speech comprises analyzing the speech at the speech analysis server and returning a result of the analyzing to a content server, wherein said step of performing a search comprises performing a search based on the result of the analyzing using the content server and obtaining a search result, and wherein said step of outputting the search result comprises outputting the search result from the content server to the computer.

13. The method of claim 1 wherein said step performing computerized monitoring with a computer of at least one side of a telephone conversation comprises performing computerized monitoring using a computer of two sides of a telephone conversation.

14. The method of claim 1 wherein said step of outputting a result of the search comprises outputting a result of the search to the first person and the second person.

15. The method of claim 1 wherein said step of outputting a result of the search comprises outputting a result of the search to a third person.

16. A system for providing at least one participant in a telephone conversation between a first person and a second person with information related to a topic of the conversation comprising:
a first data set containing words or phrases;
a second data set comprising documents; and
at least one computer receiving voice input from at least the first person, the at least one computer configured to perform automatic speech recognition on the input to find matching words or phrases in the input that match words or phrases in the first data set, to search the second data set to locate documents including the matching words or phrases, and to make the identified documents available to the first person.

17. The system of claim 16 wherein said second data set comprises a contacts list.

18. The system of claim 16 wherein said second data set comprises emails of the first or second person.

19. The system of claim 16 wherein said second data set comprises the world wide web.

20. The system of claim 16 wherein said second data set comprises a database.

21. The system of claim 16 wherein said at least one computer makes said identified documents available to the second person.

22. The system of claim 16 wherein said second data set comprises transcripts of telephone conversations.

23. The system of claim 16 wherein said at least one computer comprises a first computer configured to perform the automatic speech recognition and a second computer configured to search said second data set, wherein results of the automatic speech recognition are provided by said first computer to said second computer.

23. The system of claim 16 wherein said at least one computer comprises a first computer configured to receive audio input from the first person, a second computer configured to perform the automatic speech recognition based on an output of said first computer and a third computer configured to search said second data set based on an output of said second computer.

24. The system of claim 16 where said at least one computer comprises a first computer configured to receive audio input from the first person and the second person, a second computer configured to perform the automatic speech recognition based on an output of said first computer and a third computer configured to search said second data set based on an output of said second computer.

25. A computer readable recording medium storing a program for causing a computer to:
perform computerized monitoring with a computer of at least one side of a telephone conversation, comprising spoken words, between a first person and a second person;
automatically identify at least one topic of the conversation;
automatically perform a search for information related to the at least one topic; and
output a result of the search.
